(19) United States
(12) Patent Application Publication
(10) Pub. No.: US 2016/0359822 A1
(43) Pub. Date: Dec. 8, 2016

(54) Sovereign share encryption protocol

(71) Applicant: Adam Manuel Rivera, Elm Grove, WI (US)

(72) Inventor: Adam Manuel Rivera, Elm Grove, WI (US)

(21) Appl. No.: 14/585,311

(22) Filed: Dec. 30, 2014

Related U.S. Application Data
(60) Provisional application No. 61/922,770, filed on Dec. 31, 2013.

(51) Int. Cl. H04L 29/06

(52) U.S. Cl. CPC H04L 63/061; H04L 63/0442; H04L 63/0435

(57) ABSTRACT

The present invention is in the field of communications. More particularly, this invention is related to private electronic data exchange using multi-layered encryption and data and key separation. The invention includes a means to ensure private electronic data exchanges are secure over any medium of transmission utilizing a server which functions include authenticating and identifying users of the server, storing cryptographic keys and governing access to those cryptographic keys. Additionally the invention describes a mechanism by which the client also governs access to the private electronic data using access restrictions set forth by the sender of the private electronic data. Additionally the invention describes a mechanism by which the recipient and sender respectively are able to effectively destroy the transmitted private electronic data by instructing the server to destroy the necessary associated cryptographic key.

### FIELD OF THE INVENTION

The present invention relates generally to communications. More particularly, this invention relates to private electronic data exchange using encryption with data and key separation.

### BACKGROUND OF THE INVENTION

Electronic communication and data exchange is quickly becoming the most common form of communication in the world. Electronic communication can operate over many different mediums, including but not limited to the Internet, SMS (Short Message Service) and MMS (Multimedia Messaging Service). The Internet itself embodies many different forms of electronic communication including but not limited to Social Networking, Private Messaging, Email, Cloud Storage and many more.

Regardless of the medium, current mechanisms to secure and make private electronic communications are all subject to vulnerabilities that compromise the integrity of private communication with others and/or are too difficult to use that they are omitted from the communication process. Even where encryption is used, existing encryption protocols have been proven vulnerable by numerous successful high profile cyber-attacks. Additionally, existing encryption protocols do not allow the data owner/sender, control over the data once it has been electronically transmitted to the data recipient.

It is considered an industry standard that communications are secured by leveraging encryption on the communicated data, whether that is a file or message or other data. All existing encryption solutions operate on aging encryption protocols that have not been updated to account for the ever increasing sophistication of cyber-attackers. None of the existing encryption protocols employ a mechanism by which the data owner can control the data after transmission that does not require the transmitted data to be hosted on an intermediate server.

Others have attempted to offer control to the data owner after data transmission, but those systems all require the transmitted data be hosted on an intermediate server—a holding tank for data. This is to require the data to be actively pulled from the server by the recipient on demand over an encrypted connection. Up until that point, the data owner could have revoked or edited the data in some way; however, after the data is retrieved by the recipient, the data owner relinquishes control of the data. Additionally, hosting the data in a central or redundantly distributed location, encrypted or not, is a vulnerability data owners would prefer avoid.

For example, Jane and Bob work for a law firm that deals with sensitive information. They are unable to use cloud based security solutions because of the additional security risk involved. Jane would like to send a private legal document to Bob via email. Jane accidentally selects and sends the wrong document. The document has now been transmitted over the internet through Jane and Bob's existing email infrastructure with no way for Jane to revoke access to the email or its attachment. Additionally, if Jane or Bob's email infrastructure is hacked, the email contents would be available to the hacker.

Although many solutions attempt to protect the email in transit to the recipient, none employ a mechanism of control for the data owner that does not involve an intermediate server that holds the transmitted data. In the case of Jane and Bob, they cannot afford to risk additional exposure of their data by using a “holding tank” server. Additionally, Jane and Bob are already assuming the risk of using email as a means of secure communication where the data can be compromised.

### SUMMARY OF THE INVENTION

Methods and apparatuses for private data transmission and post-transmission data control are described herein. In one embodiment, when data is to be delivered to a recipient, the data is encrypted N times, where N is any integer greater than zero, with the outermost symmetric key being encrypted and separated from the encrypted data. The encrypted, outermost symmetric key is retained on a remote server with access restriction specifications provided by the data owner until which time the recipient chooses to access the encrypted data. The remote server determines if the key can be retrieved based on the access restriction specifications given by the sender. Without the key, the recipient would be unable to decrypt the data that was sent. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a flow diagram illustrating one embodiment of the encryption process.

FIG. 2 is a flow diagram illustrating one embodiment of the decryption process.

FIG. 3 is a flow diagram illustrating one embodiment of the use of key/data separation to enforce an expiration date after which the data would be inaccessible.

FIG. 4 is a flow diagram illustrating one embodiment of the use of key/data separation to enforce a limitation on the number of times the key is accessed.

FIG. 5 is a flow diagram illustrating one embodiment of the public key retrieval process.

FIG. 6 is a flow diagram illustrating one embodiment of the server and client pairing process.

FIG. 7 is a flow diagram illustrating one embodiment of the client policy enforcement process.

FIG. 8 is a flow diagram illustrating one embodiment of the secure communication process between client and server.

### DETAILED DESCRIPTION

Methods and apparatuses for private data transmission (e.g., emails, SMS, MMS, photos, videos) are described herein. In one embodiment, the data is symmetrically encrypted using a one-time randomly generated key (“The First Key”) producing a data cipher (“The First Data Cipher”). The First Key is asymmetrically encrypted using the public key of the recipient producing a key cipher (“The First Key Cipher”). The First Key Cipher is appended to The First Data Cipher producing a concatenated cipher (“The First Concatenated Cipher”). The First Concatenated Cipher is symmetrically encrypted using a one-time randomly generated key (“The Second Key”) producing a data cipher (“The Second Data Cipher”). A GUID (Globally Unique Identifier) is generated and encrypted, along with optional meta-data, using the public key of the recipient producing a file information cipher (“The File Information Cipher”). The Second Key is asymmetrically encrypted using the public key of the recipient producing a key cipher (“The Second Key Cipher”). The Second Key Cipher, the GUID and access restriction specifications from the sender are securely transmitted to a remote server (“The Key Server”) and stored. The File Info Cipher is appended to The Second Data Cipher producing a concatenated cipher (“The Final Cipher”). The Final Cipher is transmitted to the recipient. When the recipient chooses to access and decrypt the encrypted data, The Final Cipher is split into The File Information Cipher and The Second Data Cipher. The File Information Cipher is decrypted using the recipient's private key revealing the GUID. A request is made to The Key Server using the GUID for The Second Key Cipher. The Key Server determines if The Second Key Cipher is available for retrieval based on the access restriction specifications provided by the sender. If The Second Key Cipher is available it is returned to the recipient. The Second Key Cipher is decrypted using the recipient's private key revealing The Second Key. The Second Data Cipher is decrypted using The Second Key revealing The First Concatenated Cipher. The First Concatenated Cipher is split into The First Data Cipher and The First Key Cipher. The recipient's private key is used to decrypt The First Key Cipher revealing The First Key. The First Key is used to decrypt The First Data Cipher revealing the original data.

### Overview

In an exemplary embodiment, the sender and recipient of data each generate unique asymmetric key pairs (e.g., RSA key pair) yielding a private and public key. Each party retains their private key on the transmission device. Each party's public key is transmitted to and stored on a remote server (“The Key Server”). In an exemplary embodiment, the symmetric key is not derived from a master key, but is rather a one-time randomly generated key. In one embodiment, the encrypted, outermost symmetric key is the only valuable piece of data related to the transmission that is transmitted to The Key Server. The effect is to mitigate the risk of a cyber-attack whereby the breach of any single system yields nothing of value to the attacker. For example, in one embodiment: if an email server is breached, the attacker would not possess the encrypted, outermost symmetric key required to decrypt the transmitted email data. Furthermore, if The Key Server is breached, the attacker would not possess the transmitted email data, nor the private asymmetric key required to decrypt each outermost, encrypted symmetric key. Furthermore, if the either party's transmission device is breached and the party is aware of the breach, the symmetric keys retained by The Key Server can be destroyed on demand. The effect is to require a highly coordinated and sophisticated attack to compromise the private data. Such an attack is not practical at scale and would currently only be possible if a small number of users were targeted.

In one embodiment, the encryption is performed at or near an application level of the OSI (Open System Interconnection) model, making the processes client platform agnostic and electronic transmission medium agnostic. Encryption at this level allows for seamless integration with other software and/or processes users are accustomed to.

For the purposes of illustrations, data, such as an email message, SMS or MMS, is used as an example of transmissible data throughout this application. However, it will be appreciated that the data is not limited to email messages, SMS or MMS, and the present invention applies to all types of data, such as, for example, social media interactions, multimedia data (e.g., audio, photos, videos), bits, bytes, packets, files, and etc.

### Encryption Process

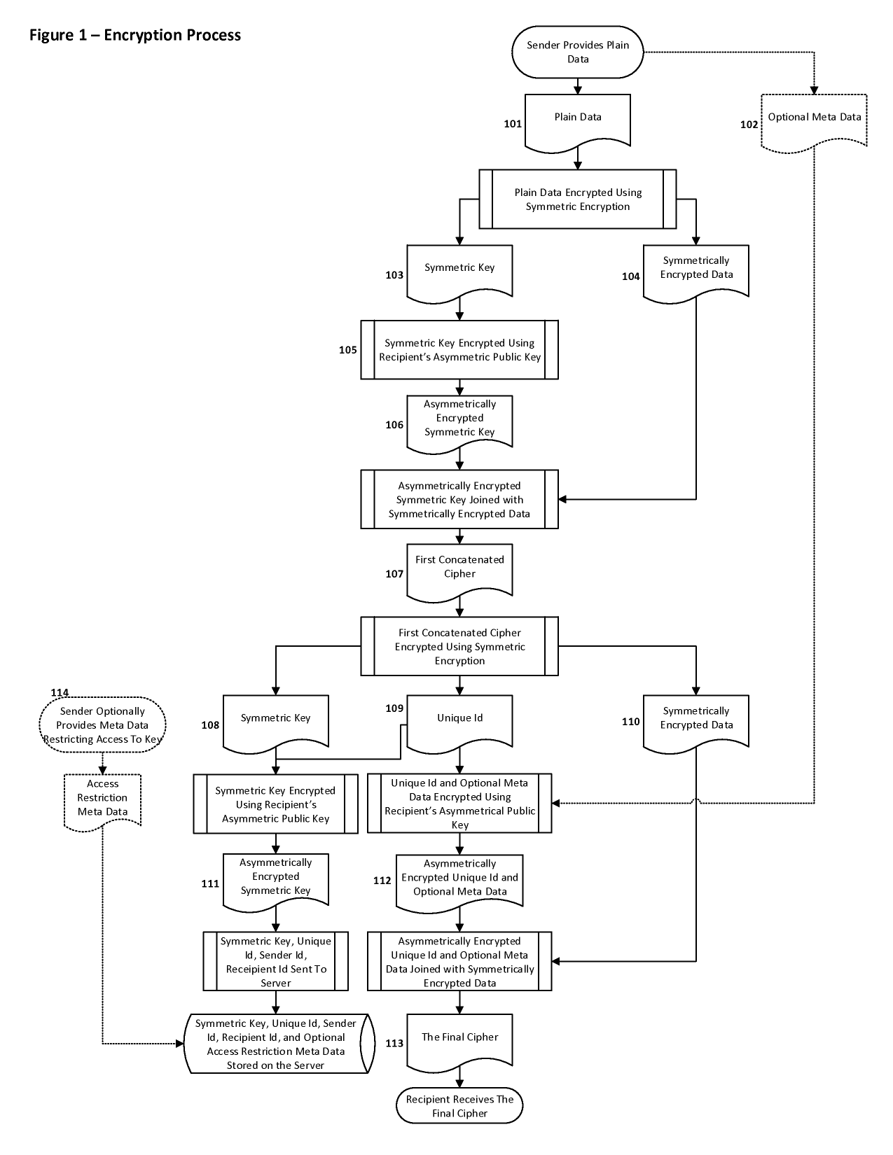

FIG. 1 is a flow diagram illustrating one embodiment of the encryption process. In one embodiment, the sender provides unencrypted (“plain”) data 101 for transmission to the recipient. The plain data 101 may be accompanied by meta-data 102 e.g. a file name. In some cases, the meta-data 102 is as sensitive as the contents of the plain data 101. The plain data 101 is symmetrically encrypted using a one-time randomly generated key 103 producing the symmetrically encrypted data 104. The symmetric key 103 must itself be protected and is thus encrypted using the recipient's asymmetric public key 105.

It will be appreciated that the term “asymmetric encryption” refers to any asymmetric encryption algorithm. Such algorithms include a public and private key. The mechanism of asymmetric encryption is well known to those in the art.

It will be appreciated that the term “symmetric encryption” refers to any symmetric encryption algorithm. Such algorithms include a single key that is used for both encryption and decryption. The mechanism of symmetric encryption is well known to those in the art.

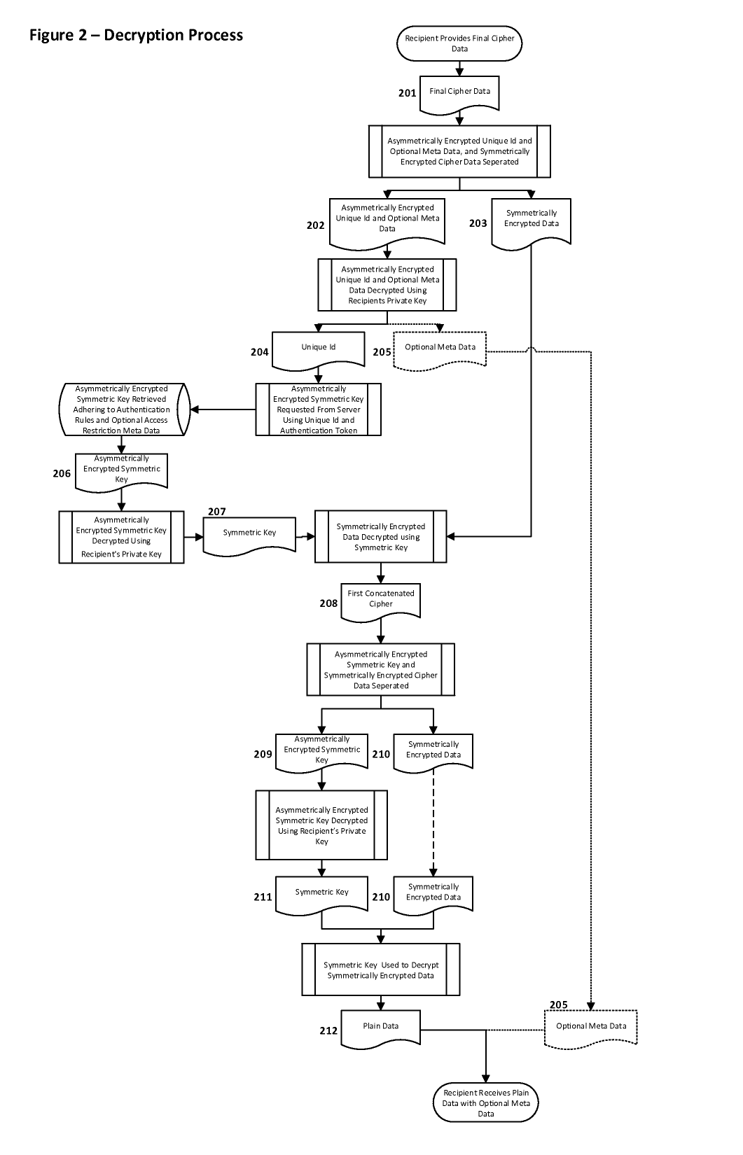

The asymmetrically encrypted symmetric key 106 is joined with the symmetrically encrypted data 104 to produce the first concatenated cipher 107. In this resulting cipher 107, both the original plain data 101 and the symmetric key 103 used to encrypt the plain data 101, are protected in such a way that only the holder of the asymmetric private key would be able to decrypt it as seen in FIG. 2, 206.

In one embodiment, the steps described from the plain data 101 to the first concatenated cipher 107 could be repeated N times, where N is any integer greater than zero. In this case, on an N+1 iteration, the plain data 101 would actually be a concatenated cipher with the same structure as the first concatenated cipher 107. The purpose of repeating the encryption steps would be to further protect the data with many layers of encryption.

The first concatenated cipher 107 is then symmetrically encrypted using a one-time randomly generated key 108 producing the symmetrically encrypted data 110. Additionally, a random unique identifier (“Unique Id”) 109 is generated and is eventually used to identify the asymmetrically encrypted symmetric key 111 on the server.

It will be appreciated that the term “server” refers to any computer within a network, including a network as broad as the Internet, which is accessible by a client computer and is able to perform the necessary tasks related to this process.

It will be appreciated that the term “client” refers to any computer, including but not limited to a cellular phone, PDA, tablet, laptop or desktop computer, which is capable of performing the necessary tasks related to this process.

The symmetric key 108 that was used to encrypt the first concatenated cipher 107 producing the symmetrically encrypted data 110 is then asymmetrically encrypted using the recipient's asymmetric public key producing the asymmetrically encrypted symmetric key 111. The asymmetrically encrypted symmetric key 111 is then transmitted securely along with the unique id 109, sender's id and recipient's id to the server.

It is noteworthy that the server is unaware of the symmetrically encrypted data 110. It is noteworthy that the server only receives an encrypted version of the symmetric key 108 and that the asymmetrically encrypted symmetric key 111 is only accessible by the authenticated recipient, and furthermore can only be decrypted by the recipient's private key. The combination of these two aspects makes the entire cryptosystem highly secure in that the central storage location, the server, does not hold anything of value to an attacker. Additionally, if the server were compromised, an attacker would only have asymmetrically encrypted keys but would lack the asymmetric private keys required to decrypt them.

It will be appreciated that the asymmetric private key is assumed to be held securely by the client. The private key is not intended to be transmitted, but rather to be held on the client permanently. If the private key were to be transferred it is assumed the transfer will be handled in secure manner, such as using encryption on the private key before moving it.

The unique id 109 and optional meta-data 102 is asymmetrically encrypted using the recipient's asymmetric public key producing the cipher 112. The cipher 112 is joined with the symmetrically encrypted data 110 producing the final cipher 113. The final cipher 113 is then transmitted to the recipient. The method of transmission of the final cipher 113 is irrelevant and could include email, SMS, MMS or any other means of communication or transmission.

Perhaps the best way to understand the strength of this encryption protocol is to understand the potential vectors of attack.

Vector of Attack 1—An attacker gains access to the server which holds the asymmetrically encrypted symmetric keys. If the server which holds the asymmetrically encrypted symmetric key 111 is compromised, the attacker would have to further gain access to the recipient's private key as well as the encrypted data. Because the server does not hold either additional required piece of data, the risk is much lower that the attack would result in the successful decryption of the final cipher 113 and the first concatenated cipher 107 revealing the plain data 101. It will be appreciated that the final cipher 113 could be the result of N number of rounds of encryption, N being any integer greater than zero, each producing a concatenated cipher 107, the last of which is encrypted and becomes the final cipher 113.

Vector of Attack 2—An attacker gains access to the final cipher 113. If an attacker is able to intercept or gain access to the final cipher 113, the attacker would need to authenticate to the server proving the recipient identity which requires information stored on the client device. The attacker would also need the recipient's private key to gain access to the unique id 109 which is required to retrieve the asymmetrically encrypted symmetric key 111 from the server. The combination of these various data points held by the recipient's client device makes a successful attack much less likely. An example technique to obtain the asymmetrically encrypted symmetric key 111 that would not require the recipient's client device would involve brute forcing the authentication credentials as well as the unique id. In one embodiment, these data points are randomly generated and contain a minimum of 16 bytes of data.

It will be appreciated that the term “brute forcing” refers to a method of attack against an unknown piece of information, typically required for authentication or access to restricted information, by which the unknown piece of information is guessed until access is obtained.

The likelihood of a successful brute force attack as described is marginally small; however, if such an attack were successful, the attacker would still need the recipient's private key to decrypt the asymmetrically encrypted symmetric key 111.

Vector of Attack 3—An attacker gains access to the recipient's device. If an attacker gained access to the recipient's device and was able to compromise the authentication credentials as well as the recipient's private key, the attacker would also need access to the final cipher 113 as well as knowledge on how to retrieve the asymmetrically encrypted symmetric key 111 from the server. This is the most vulnerable vector of attack and it will be appreciated that the recipient is assumed to take the necessary precautions to protect the device from attack, such as anti-virus software, anti-malware software, and physical access restrictions.

In all the aforementioned vectors of attack, the sender or recipient has the opportunity to remotely destroy the asymmetrically encrypted symmetric key 111 that resides on the server. This process is illustrated in FIG. 9. Once the asymmetrically encrypted symmetric key 111 is destroyed, there is no way to decrypt the final cipher 113 and the plain data 101 is effectively destroyed as there is currently no known hardware or software that can decrypt symmetrically encrypted data without the symmetric key provided a key strength of at least 256 bits is used.

In an exemplary embodiment, the minimum symmetric key size used is 256 bits. In an exemplary embodiment, the minimum asymmetric key size used is 4096 bits.

### Decryption Process

FIG. 2 is a flow diagram illustrating one embodiment of the decryption process. In one embodiment, the recipient provides the encrypted final cipher data 201 for decryption. The final cipher data 201 is split into its two parts, the asymmetrically encrypted unique id and optional meta-data 202, as well as the symmetrically encrypted data 203. The asymmetrically encrypted unique id and optional meta-data 202 is decrypted using the recipient's asymmetric private key producing the unique id 204 and the optional meta-data 205. The unique id 204 is necessary to retrieve the correct asymmetrically encrypted symmetric key 206 from the server. Without the unique id 204, along with authentication credentials identifying the recipient as the intended recipient of the final cipher data 201, the asymmetrically encrypted symmetric key 206 would not be returned from the server and further decryption would not be possible.

It will be appreciated that the term “server” refers to any computer within a network, including a network as broad as the Internet, which is accessible by a client computer and is able to perform the necessary tasks related to this process.

It will be appreciated that the term “client” refers to any computer, including but not limited to a cellular phone, PDA, tablet, laptop or desktop computer, which is capable of performing the necessary tasks related to this process.

It will be appreciated that the term “authentication credentials” refers to any means of authenticating a client to the server which proves the client's identity. For example, this could be a token or the combination of a username and password.

It will be appreciated that the term “database” refers to any storage mechanism that allows specific data retrieval based on a set of criteria.

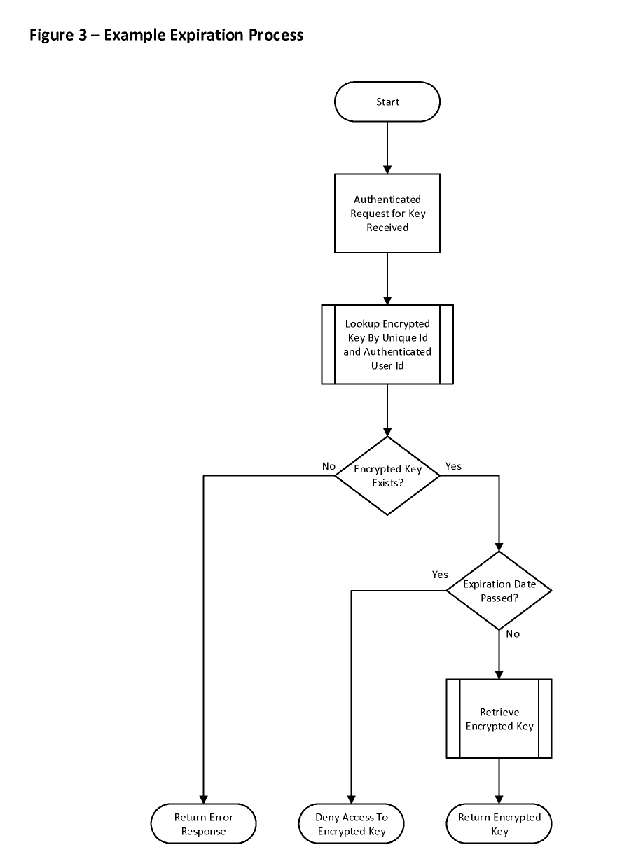

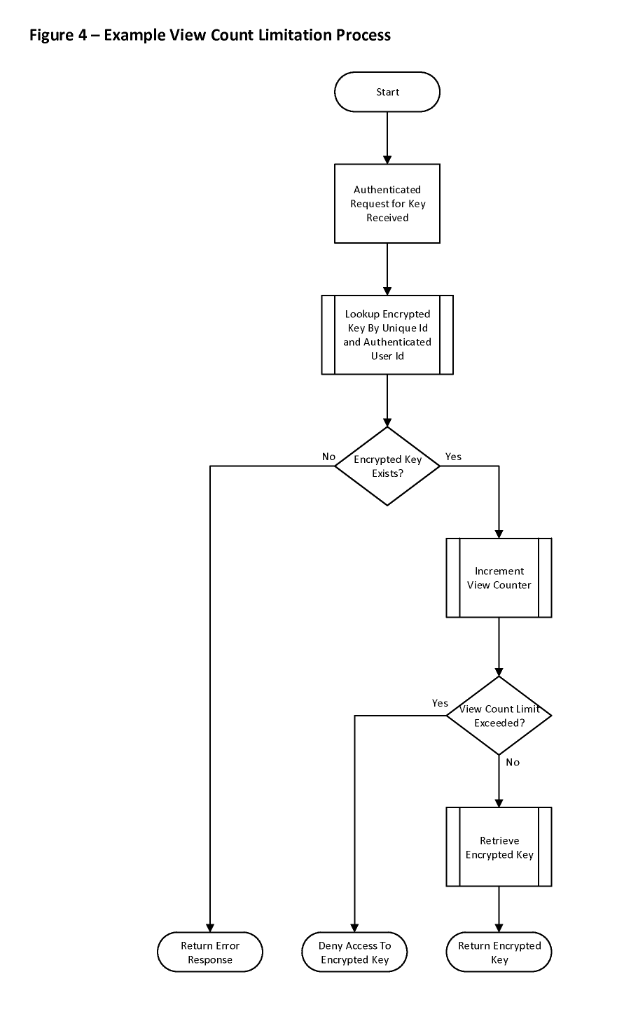

The client sends the unique id 204 and authentication credentials to the server as a request expecting a response containing the asymmetrically encrypted symmetric key 206. The server authenticates the client, and retrieves the correct asymmetrically encrypted symmetric key 206 from the database. The server further checks if the asymmetrically encrypted symmetric key 206 was stored with access restriction meta-data and if the access restriction meta-data conditions are satisfied in a way that would allow access to the asymmetrically encrypted symmetric key 206. An example of the access restriction meta-data process can be seen in FIG. 3 and FIG. 4.

One can now see that the sender has much more control over the transmitted data by virtue of specifying any number of access restriction meta-data, including but not limited to an expiration date, view count limitation, etc. If an access restriction meta-data condition is not satisfied, access is denied to the asymmetrically encrypted symmetric key 206.

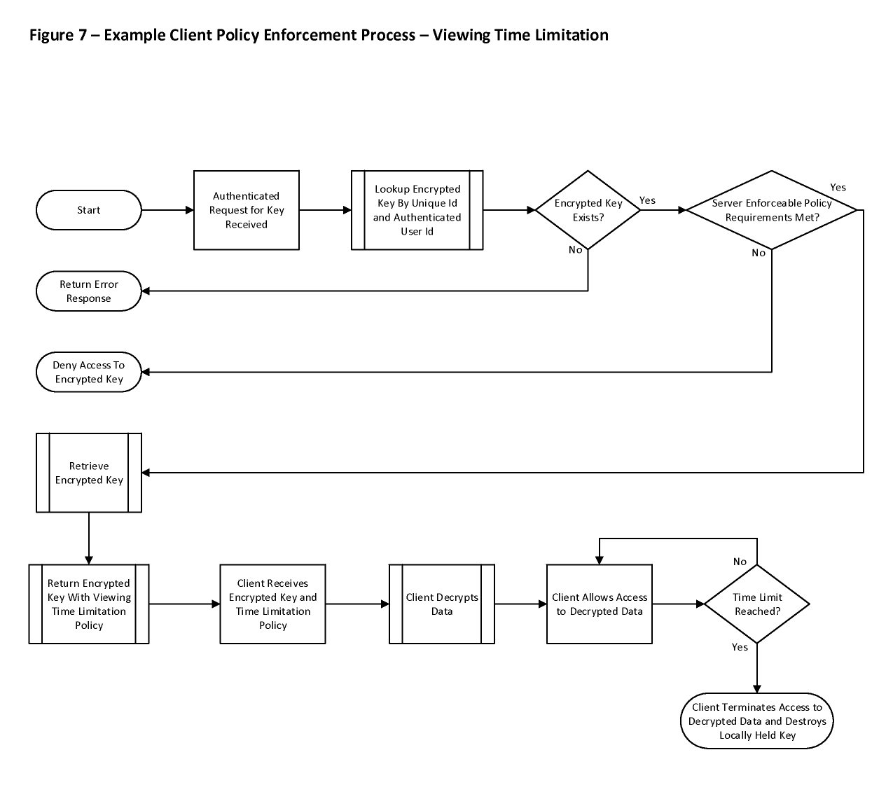

In one embodiment, access restriction meta-data may also be used to restrict the access or use of the transmitted data on the client device as well as, or in place of, the server restriction used to deny access to the asymmetrically encrypted symmetric key 206. An example of this would be limiting the time that data can be viewed on a client device. In this case, access to the asymmetrically encrypted symmetric key 206 is granted, however, the client device has received instructions with the asymmetrically encrypted symmetric key 206 to terminate access to the plain data 213 after a specified amount of time has passed. This example process is described in FIG. 7.

Assuming the aforementioned conditions are satisfied and access is granted to the asymmetrically encrypted symmetric key 206, the client receives the asymmetrically encrypted symmetric key 206 and decrypts it using the recipient's asymmetric private key producing the symmetric key 207. The symmetrically encrypted data 203 is then decrypted using the symmetric key 207 producing the first concatenated cipher 208. The first concatenated cipher 208 is then split into its two parts, the asymmetrically encrypted symmetric key 209 and the symmetrically encrypted data 210. The asymmetrically encrypted symmetric key 209 is decrypted using the recipient's asymmetric private key producing the symmetric key 211. The symmetric key 211 is then used to decrypt the symmetrically encrypted data 210 producing the plain data 212.

In one embodiment, the decryption steps from the first concatenated cipher 208 to the plain data 212 may need to be repeated N times where N is any integer greater than zero. In this case the plain data 212 would actually be another concatenated cipher with the same structure as the first concatenated cipher 208. The process starting at 208 and ending at 212 would repeat until the plain data 212 was the unencrypted representation of the data that was transmitted to the recipient.

In one embodiment, the optional meta-data 205 could be used to store a file name that the plain data 212 would be written to producing a file on the client device with that given file name.

### Example Expiration Process

FIG. 3 is a flow diagram illustrating one embodiment of the use of access restriction meta-data to restrict access to the asymmetrically encrypted symmetric key referenced in FIG. 1, 111 and FIG. 2, 206. In one embodiment, the client makes an authenticated request to the server for the asymmetrically encrypted symmetric key associated with a unique id and the client's user id. The server checks for the existence of the asymmetrically encrypted symmetric key, and, if it is not found, returns an error response to the client. If the asymmetrically encrypted key is found, the server checks if the expiration date has passed indicating access to the asymmetrically encrypted symmetric key should be denied. If the expiration date has passed, access to the asymmetrically encrypted symmetric key is denied. If the expiration date has not yet passed, access to the asymmetrically encrypted symmetric key is granted. The continuation of this process is described in FIG. 2, 206 at which point the asymmetrically encrypted symmetric key is returned to the client to continue the decryption process. If access to the asymmetrically encrypted symmetric key was denied, the continuation of the decryption process would not be possible.

It will be appreciated that this example of the use of the access restriction meta-data is not exclusive and can be combined with other uses of the access restriction meta-data.

In one embodiment, the definition of these access restriction meta-data is provided to the server by the sender as described in FIG. 1, 114.

This exemplary use of the access restriction meta-data would serve to mitigate risk that the plain data as described in FIG. 2, 212 would ever fall into the hands of an attacker or third party as the time period the asymmetrically encrypted symmetric key is available is limited.

### Example View Count Limitation Process

FIG. 4 is a flow diagram illustrating one embodiment of the use of access restriction meta-data to restrict access to the asymmetrically encrypted symmetric key referenced in FIG. 1, 111 and FIG. 2, 206. In one embodiment, the client makes an authenticated request to the server for the asymmetrically encrypted symmetric key associated with a unique id and the client's user id. The server checks for the existence of the asymmetrically encrypted symmetric key, and, if it is not found, returns an error response to the client. If the asymmetrically encrypted key is found, the server increments a counter that serves to keep track of the number of times the asymmetrically symmetric key has been accessed. The server then checks if the number of times the key has been accessed has exceeded the limitation specified in the access restriction meta-data. If the number of times the key has been accessed has exceeded the limitation specified in the access restriction meta-data, access to the asymmetrically encrypted symmetric key is denied. If the number of times the key has been accessed has not exceeded the limitation specified in the access restriction meta-data, access to the asymmetrically encrypted symmetric key is granted. The continuation of this process is described in FIG. 2, 206 at which point the asymmetrically encrypted symmetric key is returned to the client to continue the decryption process. If access to the asymmetrically encrypted symmetric key was denied, the continuation of the decryption process would not be possible.

It will be appreciated that this example of the use of the access restriction meta-data is not exclusive and can be combined with other uses of the access restriction meta-data.

In one embodiment, the definition of these access restriction meta-data is provided to the server by the sender as described in FIG. 1, 114.

This exemplary use of the access restriction meta-data would serve to mitigate risk that the plain data as described in FIG. 2, 212 would ever fall into the hands of an attacker or third party as the number of times the asymmetrically encrypted symmetric key is available is limited.

### Public Key Retrieval Process

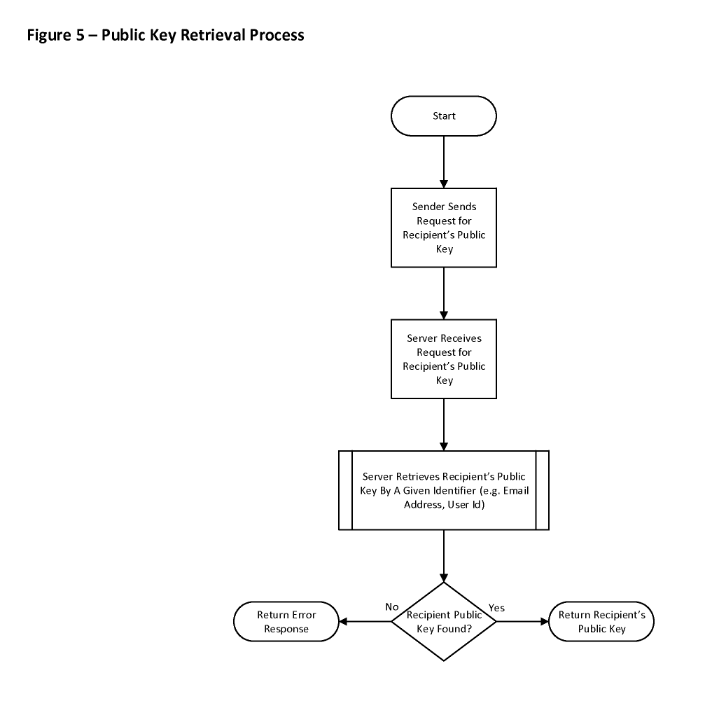

FIG. 5 is a flow diagram illustrating one embodiment of the public key retrieval process. During the encryption process as described by FIG. 1, the recipient's public key is required to protect several pieces of sensitive data; for example: FIG. 1, 105 and 106. In one embodiment, the recipient's public key is retrieved from the server. The sender sends a request to the server for the recipient's public key. The server retrieves the recipient's public key by a given identifier, such as an email address or a unique identifier for the recipient. If the recipient's public key is found, the server returns the recipient's public key. If the recipient's public key is not found, the server returns an error response.

In one embodiment, the purpose of this mechanism is to provide the recipient's public key to the sender without any active participation from the recipient at moment the sender chooses to send a piece of data to the recipient.

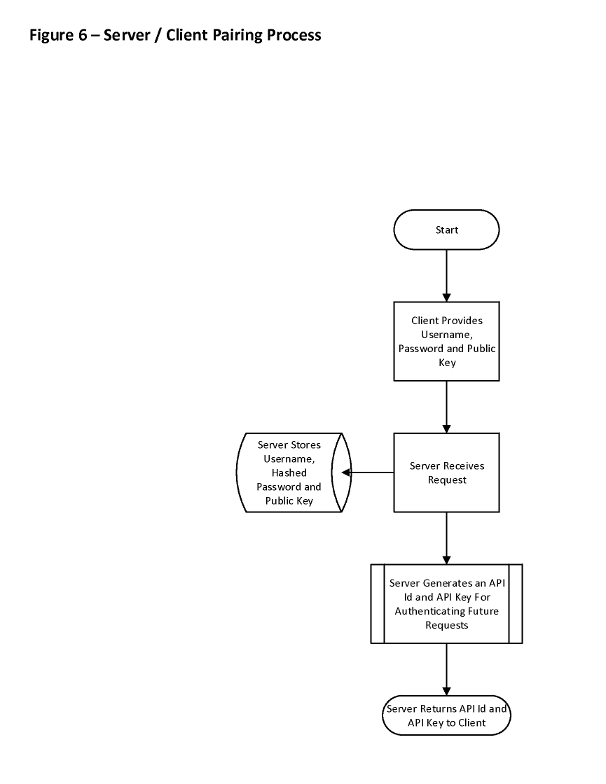

The process by which the server becomes aware of the recipient's public key, such that the server is able to distribute it to senders who request it, is described in FIG. 6.

### Server/Client Pairing Process

FIG. 5 is a flow diagram illustrating one embodiment of the server client pairing process.

It will be appreciated that the term “pairing” refers to an exchange of information between the server and client that establishes a digital relationship by which further communication can be exchanged. An example is the establishment of a set of credentials which can be used to authenticate future requests. The concept of pairing is well known to those in the art.

In one embodiment, the client provides a username, password, asymmetric public key and optional email address or other identifier. The server receives this request and stores the username, the hashed password, the asymmetric public key and optional email address or other identifier. The server returns a response to the client including a randomly generated API Id and API Key which can be used by the client for future requests as a means of authentication and proof of identity. In an exemplary embodiment the API Id and API Key would be a minimum of 16 bytes of entropy.

It will be appreciated that the term “hashed password” refers to a string that has been transformed by means of a cryptographic hashing algorithm such as SHA256. The process of hashing a string is a one way conversion that cannot be reversed; however, as the result of hashing a given string is deterministic, future authentication requests that provide a password can also be hashed and compared against the stored hash to test for a match. The purpose of storing a hash of a string rather than the string itself is so that an attacker would not gain access to the string if the server storing the hashed strings were compromised. The concept of hashing passwords is well known to those in the art.

In one embodiment, the result of this process is the server becoming aware of the client and storing identifying information about the client in a way that the client can be found by a given identifier, such as username or email address.

As described in FIG. 5, following a successful pairing process between client and server, a sender could retrieve that client's public key by a given identifier.

### Example Client Policy Enforcement Process—Viewing Time Limitation

FIG. 7 is a flow diagram illustrating one embodiment of the client policy enforcement process. In one embodiment, the client policy enforcement process can be used to limit the time a client can view the plain data referenced in FIG. 2, 212.

It will be appreciated that the term “server” refers to any computer within a network, including a network as broad as the Internet, which is accessible by a client computer and is able to perform the necessary tasks related to this process.

It will be appreciated that the term “client” refers to any computer, including but not limited to a cellular phone, PDA, tablet, laptop or desktop computer, which is capable of performing the necessary tasks related to this process.

In one embodiment, the client submits and authenticated request for the asymmetrically encrypted symmetric key, referenced in FIG. 2, 206. If the server is unable to locate the asymmetrically encrypted symmetric key by the unique id and the client's unique id, the server returns an error response to the client. If the asymmetrically encrypted symmetric key is successfully located, the server checks if an access restrictions are in place, such as an expiration date described by FIG. 3 or view count limitation described by FIG. 4, etc. If after evaluating any access restrictions, an access restriction needs to be exercised, access to the asymmetrically encrypted symmetric key is denied. If after evaluating all existing access restrictions, if any, it is determined access to the asymmetrically encrypted symmetric key should be granted, the asymmetrically encrypted symmetric key is returned to the client along with any client enforceable access restriction policies based on the access restriction meta-data.

In one embodiment, the definition of these access restriction meta-data is provided to the server by the sender as described in FIG. 1, 114.

In one embodiment, when the asymmetrically encrypted symmetric key is returned to the client along with any client enforceable access restriction meta-data, the client evaluates the access restriction meta-data and executes the specified restriction.

In one embodiment, the access restriction meta-data may define a limitation on the time the plain data referenced in FIG. 2, 212, can be accessed on the client. In one embodiment, the client decrypts the data as described in FIG. 2, and periodically checks if the viewing time limit has been reached or exceeded. If the viewing time limit has been reached or exceeded, the client terminates access to the decrypted data.

It will be appreciated that this example of the use of the access restriction meta-data is not exclusive and can be combined with other uses of the access restriction meta-data.

### Secure Server/Client Communication Process

FIG. 5 is a flow diagram illustrating one embodiment of the secure server client communication process.

Recent news has indicated nation states or other attackers may have the ability to compromise electronic communications that occur over SSL (Secure Sockets Layer). SSL is widely understood to be a core component of securing electronic communications and any vulnerability found within the SSL communication protocol would have significant, far reaching negative impact on businesses or individuals that rely on it for security. The communications described herein between client and server includes the transmission of sensitive information. If we are to assume SSL is flawed, additional protection mechanisms must be used to safeguard the transmitted data. The concept of SSL is well known to those in the art.

It will be appreciated that the term “recipient” refers to the intended recipient of the transmitted communication. It will further be appreciated that the term “sender” refers to the sender of the transmitted communication. The recipient could be the client or the server and likewise, the sender could be the client or the server. In one embodiment, the client and server both employ this method to further protect the electronic communications between each other such as described in FIG. 1 and FIG. 2.

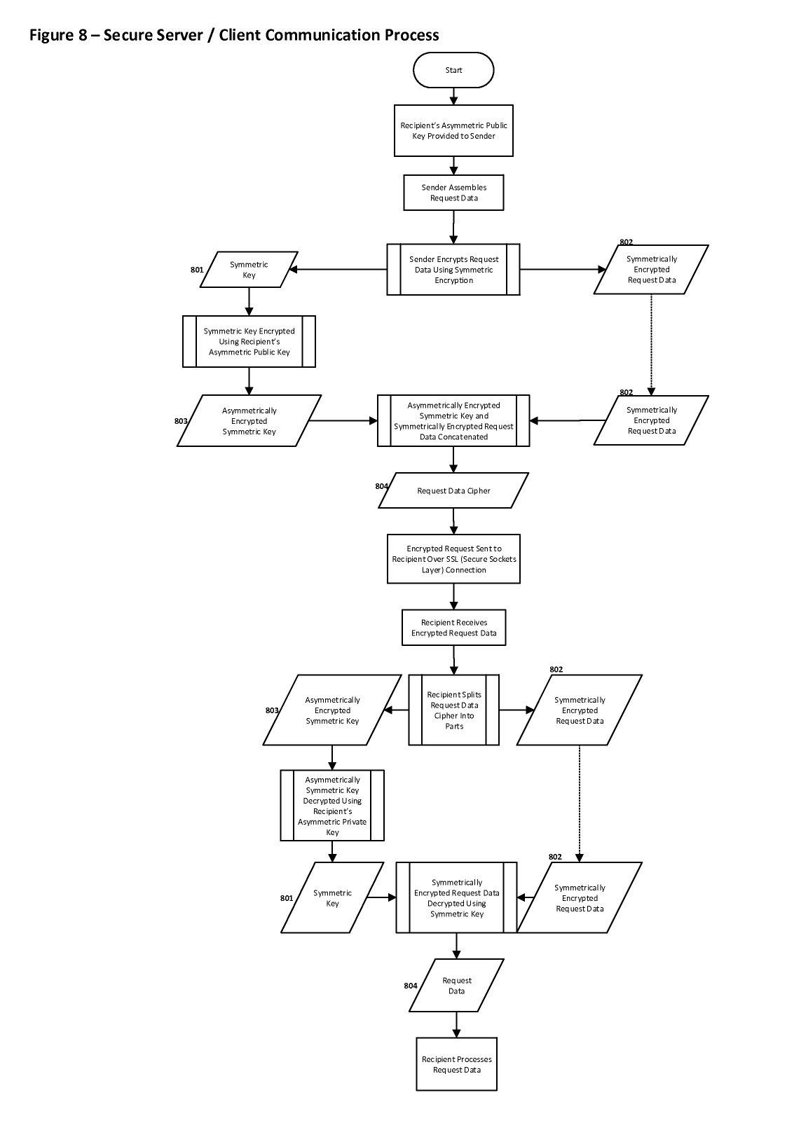

In one embodiment, the communication between sender and recipient features an additional layer of protection as described in FIG. 8. The recipient's asymmetric public key is provided to the sender. The sender assembles the request data and symmetrically encrypts it using a one-time randomly generated symmetric key 801 producing the symmetrically encrypted request data 802. The symmetric key 801 is encrypted using the recipient's asymmetric public key producing the asymmetrically encrypted symmetric key 803. The asymmetrically encrypted symmetric key 803 is joined with the symmetrically encrypted data 802 producing the request data cipher 804. The request data cipher 804 is then transmitted over SSL to the recipient.

It will be appreciated that SSL operates on a different layer of the OSI (Open Systems Interconnection) Model than the process described in FIG. 8. Whereby SSL is initiated at layer 5 of the OSI Model and operates at layer 6 of the OSI Model, and the process described in FIG. 8 is both initiated and operates at layer 7 of the OSI Model. It will be appreciated that for the purpose of this flow diagram, SSL encryption is being used but considered automatic and out of scope of description.

The request data cipher 804 is received by the recipient. The recipient splits the request data cipher 804 into its parts producing the asymmetrically encrypted symmetric key 803 and the symmetrically encrypted data 802. The asymmetrically encrypted symmetric key 803 is decrypted using the recipient's asymmetric private key producing the symmetric key 801. The symmetric key 801 is used to decrypt the symmetrically encrypted request data cipher 802 producing the request data 804. The recipient is then able to process the request data 804.

In one embodiment, the additional encryption described by FIG. 8 serves to further protect communications between server and client.

What is claimed is:

1. A method comprising: registration to the services of a server by a sender and recipient respectively in order to allow a sender to use the server as part of a secure, private electronic information transmission to a recipient; creating a unique record for the sender and recipient respectively; associating authentication credentials with the sender and recipient respectively; associating an asymmetric cryptographic public key provided by the sender and recipient respectively with their respective user records on the server; symmetrically encrypting the electronic information N times, where N is any integer greater than one, using a unique symmetric key for each symmetric encryption operation performed where the symmetric key is not derived from a master key; asymmetrically encrypting the symmetric key or keys used to symmetrically encrypt the electronic information using the recipient's asymmetric cryptographic public key; joining the first N-1 asymmetrically encrypted symmetric keys with their respective symmetrically encrypted data, where N is the number of rounds of symmetric encryption employed; transmitting the last asymmetrically encrypted symmetric key to the server and associating it with a record on the server for an electronic information transmission identified by a unique identifier; associating optional access restriction meta-data specified by the sender with a record on the server for an electronic information transmission identified by a unique identifier; encrypting an asymmetrically encrypted symmetric key's unique identifier using the recipient's asymmetric public key; asymmetrically encrypting optional electronic information meta-data using the recipient's asymmetric public key; transmitting the symmetrically encrypted electronic information along with the asymmetrically encrypted unique identifier that identifies the asymmetrically encrypted symmetric key on the server and the asymmetrically encrypted optional electronic information meta-data to the recipient; retrieving the asymmetrically encrypted symmetric key from the server using the unique identifier associated with the record for the asymmetrically encrypted symmetric key on the sever; denying access to the asymmetrically encrypted symmetric key using optional access restriction meta-data specified by the sender; destruction of the asymmetrically encrypted symmetric key stored on the server at the request of either the sender or the recipient; transmission of the optional access restriction meta-data to the recipient; transmission of the recipient's asymmetric public key to the sender; client enforcement of access restriction policies described by the optional access restriction meta-data that serve to govern access to the electronic information; server enforcement of access restriction policies described by the optional access restriction meta-data which serve to govern access to the asymmetrically encrypted symmetric key;

2. The method of claim 1, wherein the electronic information is an electronic mail message.

3. The method of claim 1, wherein the electronic information is one or more selected from a group consisting of electronic bits, bytes, packets or files.

4. The method of claim 1, wherein the electronic information is a data stream.

5. The method of claim 1, wherein the client is any computing device capable of performing the tasks described, such as encryption, decryption, information transmission and etc.

6. The method of claim 1, wherein the server is any computing device capable of performing the tasks described, such as encrypted, decryption, information transmission and etc.

7. The method of claim 1, wherein meta-data includes one or more data that is in addition to the electronic information.
